(19) United States
(12) Patent Application Publication
(10) Pub. No.: US 2019/0272078 A1
(43) Pub. Date: Sep. 5, 2019

(54) FLOATING TOUCH CONTROL SENSING METHOD, FLOATING TOUCH CONTROL SENSING SYSTEM, AND NON-TRANSITORY COMPUTER READABLE STORAGE MEDIUM

(71) Applicant: SHENZHEN ROYOLE TECHNOLOGIES CO. LTD., Shenzhen (CN)

(72) Inventors: Qi LIN, Shenzhen (CN); Songling YANG, Shenzhen (CN); Fan YANG, Shenzhen (CN)

(21) Appl. No.: 16/418,281

(22) Filed: May 21, 2019

Related U.S. Application Data
(63) Continuation of application No. PCT/CN2016/106758, filed on Nov. 22, 2016.

(51) Int. Cl. G06F 3/041; G06F 3/0488

(52) U.S. Cl. CPC G06F 3/04186; G06F 2203/04101; G06F 3/04886

(57) ABSTRACT

A floating touch control sensing method is applicable to a floating touch control electronic device. The floating touch control electronic device includes a touch display panel. The touch display panel includes a number of icon hotspot areas and a non-icon hotspot area. The floating touch control sensing method includes: sensing a floating position of a touch object; and responding to a touch control operation performed outside the icon hot-spot areas, not responding to a touch control operation performed inside the icon hotspot areas when the floating position is determined to be higher than a preset position. A floating touch control sensing system and a floating touch control electronic device are further provided.

### CROSS-REFERENCE TO RELATED APPLICATION

This application is a continuation of PCT/CN2016/106758, filed on Nov. 22, 2016, the disclosure of which is hereby incorporated by reference in its entirety.

### TECHNICAL FIELD

The present disclosure relates to the field of electronics, and in particular, to a floating touch control sensing method, a floating touch control sensing system, and a non-transitory computer readable storage medium.

### BACKGROUND

In recent years, with the rapid development of microelectronics technology, computer hardware, and software technology, terminal devices have foundations to handle complex operations. In addition, users hope that the terminal devices are more powerful, more flexible, and more simpler. With the development of terminal technology, input devices of the terminal devices are gradually changed from original physical buttons to virtual buttons which are also commonly referred to as soft buttons or soft keyboards. However, input technology for the terminal device still needs to be improved. For example, existing input modes are relatively simple and user experiences are insufficient. Since a size of a screen of the terminal device limits a size of a touch keyboard, the user is likely to make a mistake “click” in inputting operations. Since touch control operations on the touch screen for input is gradually developed to exhaustion, it is expected to develop other non-touching operations for effective input. Floating touch technology applies mutual-capacitance capacitive sensors and self-capacitance capacitive sensors to work at the same time. In brief, the floating touch technology may allow the finger of the user to perform a touch control operation without touching the screen. However, when performing the floating touch control operation, it is not easy for the user to accurately click a desired position (i.e., an icon) on the screen due to a distance between the finger and the screen. For example, when a target point of the floating touch control operation is just in a touch hotspot area of an icon, such as, the finger of the user just floats on an edge of the icon, a false touch may occur and the icon may automatically open instead of an expecting operation.

### SUMMARY

Embodiments of the present disclosure provide a floating touch control sensing method, a floating touch control sensing system, and a non-transitory computer readable storage medium to prevent a false touch control operation and improve the accuracy of touch control operation.

An embodiment of the present disclosure provides a floating touch control sensing method that is applicable to a floating touch control electronic device. The floating touch control electronic device includes a touch display panel. The touch display panel includes a number of icon hotspot areas and a non-icon hotspot area. The floating touch control sensing method includes: sensing a floating position of a touch object; and responding to a touch control operation outside the icon hotspot areas, not responding to a touch control operation performed inside the icon hotspot areas when the floating position is determined to be higher than a preset position.

A corresponding touch control operation is responded when the floating position is determined to be not higher than the preset position.

Responding to the corresponding touch operation includes responding to a touch control operation inside the icon hotspot areas when the floating position corresponds to the icon hotspot areas, and responding to a touch control operation outside the icon hotspot areas when the floating position corresponds to the non-icon hotspot area.

A voltage corresponding to the number of icon hotspot areas is lower than a voltage corresponding to an area outside the icon hotspot areas.

A floating touch control operation with a height less than or equal to a first response distance corresponding to the icon hotspot areas is responded. A floating touch control operation with a height less than or equal to a second response distance corresponding to the non-icon hotspot areas is responded. The first response distance corresponding to the icon hotspot areas is shorter than the second response distance corresponding to the non-icon hotspot area.

A voltage corresponding to the icon hotspot areas is equal to a voltage corresponding the non-icon hotspot area.

Maximum sensing distance corresponding to the icon hotspot areas to be capable of being sensed and maximum sensing distance corresponding to the non-icon hotspot area to be capable of being sensed are same, and are higher than the first response distance and the second response distance.

The preset position is the first response distance.

Responding to the touch control operation outside the icon hotspot areas includes aggregating icons.

An embodiment of the present disclosure provides a floating touch control sensing system that is applicable to a floating touch control electronic device including a touch display panel. The touch display panel includes a number of icon hotspot areas and a non-icon hotspot areas area. The floating touch control sensing system includes a processor, and a computer readable storage coupled to the processor via a bus. The computer readable storage stores at least one computer executable instruction thereon which, when executed by the processor, causes the processor to carry out the following actions including sensing a floating position of a touch object; determining whether the floating position is higher than a preset position; and responding to a touch control operation outside the icon hotspot areas, not responding to a touch control operation inside the icon hotspot areas when the floating position is determined to be higher than the preset position.

The at least one computer executable instruction thereon which, when executed by the processor, causes the processor to carry out actions including responding to a corresponding touch control operation when the floating position is determined to be not higher than the preset position.

The at least one computer executable instruction thereon which, when executed by the processor, causes the processor to carry out actions including sensing an area corresponding to the floating position of the touch object; outputting a first position signal when the sensed area corresponding to the floating position is located inside the icon hotspot areas; outputting a second position signal when the sensed area corresponding to the floating position is located outside the icon hotspot areas; responding to the touch operation corresponding to the icon hotspot areas according to the first position signal; and responding the touch operation corresponding to the area outside the icon hotspot areas according to the second position signal.

A voltage corresponding to the number of icon hotspot areas is lower than a voltage corresponding to the area outside the icon hotspot areas.

The at least one computer executable instruction thereon which, when executed by the processor, causes the processor to carry out actions including responding a floating touch control operation with a height less than or equal to a first response distance wherein the floating touch control operation corresponds to the icon hotspot areas; and responding a floating touch control operation with a height less than or equal to a second response distance wherein the floating touch control operation corresponds to the non-icon hotspot area, wherein the first response distance corresponding to the icon hotspot areas is shorter than the second response distance corresponding to the non-icon hotspot area.

A voltage corresponding to the icon hotspot areas is equal to a voltage corresponding to the non-icon hotspot area.

Maximum sensing distance corresponding to the icon hotspot areas to be capable of being sensed and maximum sensing distance corresponding to the non-icon hotspot area to be capable of being sensed are same, and are higher than the first response distance and the second response distance.

The preset position is the first response distance.

The at least one computer executable instruction thereon which, when executed by the processor, causes the processor to carry out actions including aggregating icons for responding to the touch control operation outside the icon hotspot areas.

A non-transitory computer readable storage medium storing computer programs is provided and applicable to a floating touch control electronic device including a touch display panel including a number of icon hotspot areas and a non-icon hotspot areas area. The computer programs, when executed by a processor, are operable with the processor carry out the following actions including sensing a floating position of a touch object; determining whether the floating position is higher than a preset position; and responding to a touch control operation outside the icon hotspot areas, not responding to a touch control operation inside the icon hotspot areas when the floating position is determined to be higher than the preset position.

The computer programs which, when executed by the processor, are further operable with the processor carry out actions including responding to a corresponding touch control operation when the floating position is determined to be not higher than the preset position.

The floating touch control sensing method of present disclosure is applicable to the floating touch control electronic device including the touch display panel. The touch display panel includes the icon hotspot areas and the non-icon hotspot area. The floating touch control sensing method includes: sensing the floating position of the touch object; and responding to the touch control operation outside the icon hotspot areas when the floating position is determined to be higher than the preset position. Therefore, false touch control operations are avoided by setting the preset position to improve the accuracy of the touch control operation.

### BRIEF DESCRIPTION OF THE DRAWINGS

To better illustrate the technical solutions of embodiments of the present disclosure, the following descriptions will briefly illustrate the accompanying drawings described in the embodiments. Obviously, the following described accompanying drawings are merely some embodiments of the present disclosure. Those skilled in the art may obtain other accompanying drawings according to the described accompanying drawings without creative efforts.

FIG. 1 is a flow chart of a floating touch control sensing method according to an embodiment of a first aspect of the present disclosure.

FIG. 2 is a block diagram of a floating touch control sensing system according to an embodiment of a second aspect of the present disclosure.

FIG. 3 is a block diagram of a floating touch control electronic device according to an embodiment of a third aspect of the present disclosure.

FIG. 4 is a schematic view of a touch display panel of FIG. 3.

FIG. 5 is a block diagram of a floating touch control sensing system according to an embodiment of the present disclosure.

### DETAILED DESCRIPTION OF ILLUSTRATED EMBODIMENTS

The technical solutions of embodiments of the present disclosure will be described clearly and completely in combination with the accompanying drawings of the embodiments of the present disclosure.

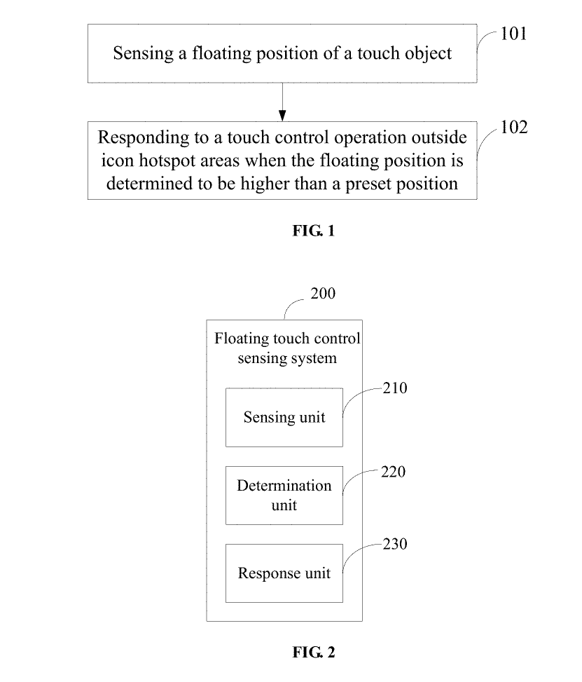

FIG. 1 illustrates a floating touch control sensing method according to an embodiment of a first aspect of the present disclosure. Also illustrated in FIGS. 2 to 4, the floating touch control sensing method is applicable to a floating touch control electronic device 300. The floating touch control electronic device 300 includes a touch display panel 310. The touch display panel 310 includes a number of icon hotspot areas 312 and a non-icon hotspot area 314. The floating touch control sensing method includes operations at the following blocks.

At block 101, a floating position of a touch object is sensed.

It should be noted that, a touch control operation may be performed on the touch display panel 310 when using the floating touch control electronic device 300. That is, without directly touching a screen of the touch display panel 310, the touch object (such as a finger) may directly select items on the screen of the touch display panel 310 like a mouse when the touch object suspends in the air. The floating position of the touch object is a distance between the touch object and the screen of the touch display panel 310.

At block 102, when the floating position is determined to be higher than a preset position, the touch control operation outside the icon hotspot areas 312 is responded and the touch control operation inside the icon hotspot areas 312 are not responded.

It should be noted that, it needs to determine whether the floating position is higher than the preset position after the floating position of the touch object is sensed. When the floating position is determined to be higher than the preset position, it indicates that applications corresponding to the non-icon hotspot areas 314 are required to be launched, that is, applications located outside the icon hotspot areas 312 are required to respond. At the same time, even though the touch object is located inside the icon hotspot areas 312, the corresponding applications are not triggered. Therefore, false touch control operations are avoided to improve the accuracy of the touch control operations. The preset position may be adjusted according to practical needs.

The response to the touch control operation located outside the icon hotspot areas 312 includes displaying shortcut gestures. The shortcut gestures include aggregating icons, opening menu bars, and the like.

The floating touch control sensing method further includes the following operations.

When the floating position is determined to be not higher than the preset position, a corresponding touch control operation is responded.

Specifically, when the floating position corresponds to an area inside the icon hotspot areas 312, the touch control operation inside the icon hotspot areas 312 is responded. When the floating position corresponds to the non-icon hotspot area 314, the touch control operation outside the icon hotspot areas 312 is responded.

It should be noted that, when the floating position of the touch object is determined to be not higher than the preset position, the touch control operation whether an area corresponding to the floating position of the touch object is located inside the icon hotspot areas 312 or outside the icon hotspot areas 312 may be responded.

Furthermore, a voltage corresponding to the icon hotspot areas 312 is lower than a voltage corresponding to an area outside the icon hotspot areas 312.

Specifically, the voltage corresponding to the icon hotspot areas 312 may be set at a low level and the voltage corresponding to the area outside the icon hotspot areas 312 may be set at a high level. When the touch object is located inside the icon hotspot areas 312 and the floating position of the touch object is not higher than the preset position, the corresponding touch control operation may be responded.

It should be noted that, since the voltage corresponding to the icon hotspot areas 312 is at a low level, the touch object may not be sensed and the corresponding touch control operation may not be responded when the floating position of the touch object is higher than the preset position and the touch object is located inside the icon hotspot areas 312. However, since the voltage corresponding to the area outside the icon hotspot areas 312is at a high level, the touch object is sensed and the corresponding touch control operation is responded when the floating position of the touch object is higher than the preset position and the touch object is located outside the icon hotspot areas 312. Therefore, false touch control operations are avoided to improve the accuracy of the touch control operations.

In addition, when the floating position of the touch object is not higher than the preset position, the touch object may be sensed and the corresponding touch control operation may be responded whether the touch object corresponds to the icon hotspot areas 312or the non-icon hotspot area 314.

In other embodiments, without setting the voltage corresponding to the icon hotspot area 312 and the voltage corresponding to the area outside the icon hotspot areas 312, the false touch may be avoided only by setting a determination threshold of the preset position. That is, when the voltage corresponding to the icon hotspot areas and the voltage corresponding to the non-icon hotspot area 314 are the same, the floating position (i.e., the distance of the touch object relative to the screen) where the floating touch control operations corresponding to the icon hotspot areas 312 and the non-icon hotspot area 314 to be capable of being sensed are the same, that is, sensing distances are the same. The sensing distance is a distance between the touch object and the screen where the floating touch control operation corresponding to the non-icon hotspot areas 314 or corresponding to the icon hotspot areas 312 may be sensed. A first response distance with a smaller value is set corresponding to the icon hotspot areas 312 and a second response distance with a smaller value is set corresponding to the non-icon hotspot area 314. The response distance is a distance between the touch object and the screen where floating touch control operations may be responded. The second response distance is greater than the first response distance. When the touch object with a height within a certain sensing range is located above the icon hotspot areas 312 or non-icon hotspot area 314, the touch control operation of the touch object corresponding to the icon hotspot areas 312 or the non-icon hotspot area 314 may be sensed. A capacitance between the touch object and the screen varies with the distance between the touch object and the screen. Therefore, a control unit electrically coupled to the screen may calculate a current distance between the touch object and the screen according to the capacitance. The first response distance and the second response distance are shorter than the sensing distances. When the calculated distance is higher than the first response distance corresponding to the icon hotspot areas 312, the touch control operation of the touch object corresponding to the icon hotspot areas 312 is ignored by the control unit, that is, the touch control operation corresponding to the icon hotspot areas 312 is not responded. When the calculated distance is shorter than the second response distance corresponding to the non-icon hotspot area 314, the touch control operation corresponding to the non-icon hotspot area 314 is received by the control unit, that is, the touch control operation corresponding to the non-icon hotspot area 314 is responded. When the calculated distance is shorter than the first response distance corresponding to the icon hotspot areas 312, the touch control operation corresponding to the icon hotspot areas 312 is received by the control unit, that is, the touch control operation corresponding to the icon hotspot areas 312 is responded. Furthermore, the screen may also be an infrared touch screen including infrared emitters and infrared receivers disposed at a rear or a side thereof for sensing a height of the touch object relative to the screen and a coordinate position of the touch object.

As illustrated in FIG. 2, a floating touch control sensing system 200 according to an embodiment of a second aspect of the present disclosure is provided. The floating touch control sensing system 200 is applied to the floating touch control electronic device 300. The floating touch control sensing system 200 includes a sensing unit 210, a determination unit 220, and a response unit 230.

The sensing unit 210 is operated to sense the floating position of the touch object.

It should be noted that, the touch control operation may be performed on the touch display panel 310 when using the floating touch control electronic device. That is, without directly touching the screen of the touch display panel 310, the touch object (such as the finger) may directly select items on the screen of the touch display panel 310 like a mouse when the touch object suspends in the air. The floating position of the touch object is the distance between the touch object and the screen of the touch display panel 310.

The determination unit 220 is operated to determine whether the floating position is higher than the preset position. When the floating position is determined to be higher than the preset position, a first response signal is output. The response unit 230 is operated to respond to the touch control operation outside icon hotspot areas 312 and is not operated to respond to the touch control operation inside the icon hotspot areas 312 according to the first response signal.

It should be noted that, the determination unit 220 is operated to determine whether the floating position is higher than the preset position after the sensing unit 210 senses the floating position of the touch object. When the floating position is determined to be higher than the preset position, it indicates that the application corresponding to the non-icon hotspot area 314 is required to be launched, that is, the application located outside the icon hotspot areas 312 is required to respond. At this time, the response unit 230 starts the application located outside the icon hotspot areas 312 according to the first response signal. At the same time, even though the touch object is located inside the icon hotspot areas 312, the corresponding applications are not triggered. Therefore, false touch control operations are avoided by setting the preset position to improve the accuracy of the touch control operation.

The responses to the touch control operations located outside the icon hotspot areas 312 includes the displaying shortcut gestures. The shortcut gestures include aggregating icons, opening menu bars, and the like.

The determination unit 220 is further operated to output a second response signal when the floating position is determined to be not higher than the preset position. The response unit 230 is further operated to respond to the touch control operation according to the second response signal.

Specifically, the sensing unit 210 is further operated to sense an area corresponding to the floating position of the touch object. When the sensing unit 210 senses that the sensed area of the floating position is located inside the icon hotspot areas 312, a first position signal is output. When the sensing unit 210 senses that the sensed area of the floating position is located outside the icon hotspot areas 312, a second position signal is output. The response unit 230 is operated to respond to the touch control operation inside the icon hotspot areas 312 according to the first position signal, and further operated to respond to the touch control operation outside the icon hotspot areas 312 according to the second position signal.

It should be noted that, when the floating position of the touch object is determined to be not higher than the preset position, the touch control operation whether an area corresponding to the floating position of the touch object is located inside the icon hotspot areas 312 or outside the icon hotspot areas 312 may be responded.

Furthermore, the voltage corresponding to the icon hotspot areas 312 is lower than the voltage corresponding to the area outside the icon hotspot areas 312.

The voltage corresponding to the icon hotspot areas 312 may be set at a low level, and the voltage corresponding to the area outside the icon hotspot areas 312 may be set at a high level. When the touch object is located inside the icon hotspot areas 312 and the floating position is not higher than the preset position, the corresponding touch control operation may be responded.

It should be noted that, since the voltage corresponding to the icon hotspot areas 312 is at a low level, the touch object may not be sensed and the corresponding touch control operation may not be responded when the floating position of the touch object is higher than the preset position and the touch object is located inside the icon hotspot areas 312. However, since the voltage corresponding to the area outside the icon hotspot areas 312 is at a high level, the touch object is sensed and the corresponding touch control operation is responded when the floating position of the touch object is higher than the preset position and the touch object is located outside the icon hotspot areas 312. The preset position is set. The voltage corresponding to the icon hotspot areas 312 is set at the low level and the voltage corresponding to the area outside the icon hotspot areas 312 is set at the high level. Therefore, false touch control operations are avoided to improve the accuracy of the touch control operations.

In addition, when the floating position of the touch object is not higher than the preset position, the touch object may be sensed and the corresponding touch control operation may be responded whether the touch object corresponds to the icon hotspot areas 312 or the non-icon hotspot area 314.

In other embodiments, without setting the voltage corresponding to the icon hotspot area 312 and the voltage corresponding to the area outside the icon hotspot areas 312, the false touch may be avoided only by setting a determination threshold of the preset position. That is, when the voltage corresponding to the icon hotspot areas and the voltage corresponding to the non-icon hotspot area 314 are the same, the floating position (i.e., the distance of the touch object relative to the screen) where the floating touch control operations corresponding to the icon hotspot areas 312 and the non-icon hotspot area 314 to be capable of being sensed are the same, that is, sensing distances are the same. A first response distance with a smaller value is set corresponding to the icon hotspot areas 312 and a second response distance with a smaller value is set corresponding to the non-icon hotspot area 314. The second response distance is greater than the first response distance. When the touch object with the height within the certain sensing range is located above the icon hotspot areas 312 or non-icon hotspot area 314, the touch control operation of the touch object corresponding to the icon hotspot areas 312 or the non-icon hotspot area 314 may be sensed. The capacitance between the touch object and the screen varies with the distance between the touch object and the screen. Therefore, the control unit electrically coupled to the screen may calculate the current distance between the touch object and the screen according to the capacitance. The first response distance and the second response distance are slightly shorter than the sensed distance. When the calculated distance is higher than the first response distance corresponding to the icon hotspot areas 312, the touch control operation of the touch object corresponding to the icon hotspot areas 312 is ignored by the control unit, that is, the touch control operation corresponding to the icon hotspot areas 312 is not responded. When the calculated distance is shorter than the second response distance corresponding to the non-icon hotspot area 314, the touch control operation corresponding to the non-icon hotspot area 314 is received by the control unit, that is, the touch control operation corresponding to the non-icon hotspot area 314 is responded. When the calculated distance is shorter than the first response distance corresponding to the icon hotspot areas 312, the touch control operation corresponding to the icon hotspot areas 312 is received by the control unit, that is, the touch control operation corresponding to the icon hotspot areas 312 is responded. Furthermore, the screen may also be the infrared touch screen including infrared emitters and infrared receivers disposed at the rear or the side thereof for sensing the height of the touch object relative to the screen and the coordinate position of the touch object. Maximum sensing distance corresponding to the icon hotspot areas to be capable of being sensed and maximum sensing distance corresponding to the non-icon hotspot area to be capable of being sensed are same, and are higher than the first response distance and the second response distance.

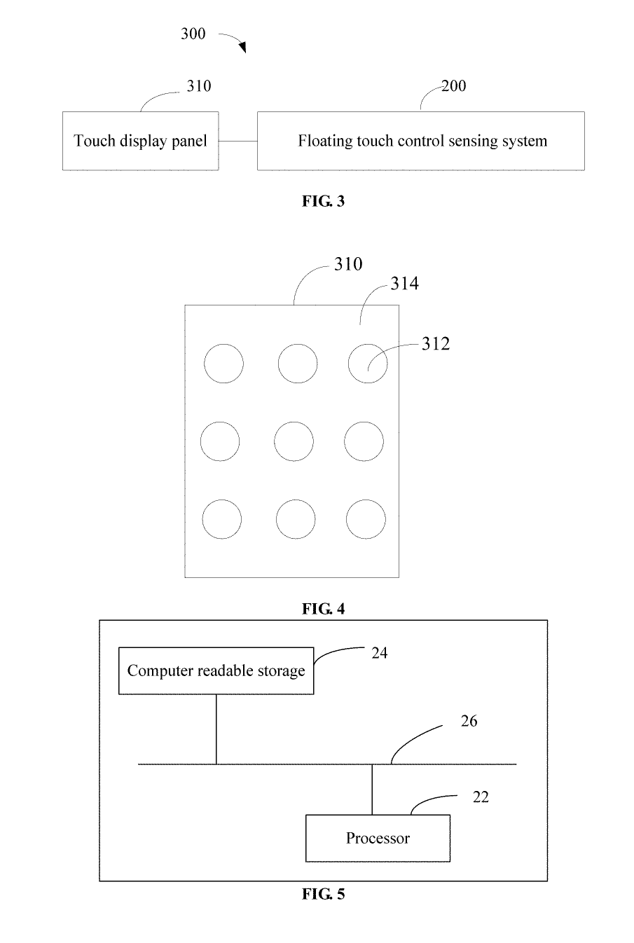

As illustrated in FIG. 3 and FIG. 4, the electronic device 300 includes the touch display panel 310 and the floating touch control sensing system 200. The touch display panel 310 includes the icon hotspot areas 312 and the non-icon hotspot area 314 located outside the icon hotspot areas 312. The floating touch control sensing system 200 for sensing the floating touch control has been described in detail in the above embodiment of the second aspect of the present disclosure, and details are not described herein again.

In the embodiment, the floating touch control electronic device 300 includes the touch display panel 310 and the floating touch control sensing system 200. The floating touch control sensing system 200 includes the sensing unit 210, the determination unit 220, and the response unit 230. After the sensing unit 210 senses the floating position of the touch object, the determination unit 220 is operated to determine whether the floating position is higher than the preset position. When the floating position is determined to be higher than the preset position, it indicates that the application corresponding to the non-icon hotspot area 314 is required to be launched, that is, the applications located outside the icon hotspot areas 312 are required to respond. At this time, the response unit 230 starts the application located outside the icon hotspot areas 312 according to the first response signal. At the same time, even though the touch object is located inside the icon hotspot areas 312, the corresponding applications are not triggered. Therefore, false touch control operations are avoided to improve the accuracy of the touch control operations.

As illustrated in FIG. 5, these components illustrated in FIG. 2 may be integrated into a processor 22 for example. The processor 22 may be coupled to a computer readable storage 24 such as a memory by a bus 26.The computer readable storage 24 is configured to store at least one computer executable instruction thereon which, when executed by the processor 22, causes the processor 22 to carry out the floating touch control sensing method above mentioned, which will not be repeated herein.

In addition, a non-transitory computer readable storage medium storing computer programs is provided. The programs, when executed by a processor, are operable with the processor carry out the following actions including sensing a floating position of a touch object; determining whether the floating position is higher than a preset position; and responding to a touch control operation outside the icon hotspot area, not responding to a touch control operation inside the icon hotspot areas when the floating position is determined to be higher than the preset position.

The embodiments of the present disclosure are described in detail above. It should be noted that those skilled in the art may make some modifications and improvements without departing from the principle of the present disclosure. Those modifications and improvements are also considered to be within the scope of the present disclosure.

What is claimed is:

1. A floating touch control sensing method applicable to a floating touch control electronic device, comprising a touch display panel including a plurality of icon hotspot areas and a non-icon hotspot area, the method comprising:
sensing a floating position of a touch object; and
responding to a touch control operation performed outside the icon hotspot areas, not responding to a touch control operation performed inside the icon hotspot areas when the floating position is determined to be higher than a preset position.

2. The method of claim 1, further comprising:
responding to a corresponding touch control operation when the floating position is determined to be not higher than the preset position.

3. The method of claim 2, wherein responding to the corresponding touch control operation comprises:
responding to a touch control operation inside the icon hotspot areas when the floating position corresponds to the icon hotspot areas; and
responding to a touch control operation outside the icon hotspot areas when the floating position corresponds to the non-icon hotspot area.

4. The method of claim 1, wherein a voltage corresponding to the plurality of icon hotspot areas is lower than a voltage corresponding to an area outside the icon hotspot areas.

5. The method of claim 1, further comprising:
responding a floating touch control operation with a height less than or equal to a first response distance corresponding to the icon hotspot areas; and
responding a floating touch control operation with a height less than or equal to a second response distance corresponding to the non-icon hotspot area, wherein the first response distance corresponding to the icon hotspot areas is shorter than the second response distance corresponding to the non-icon hotspot area.

6. The method of claim 5, wherein a voltage corresponding to the icon hotspot areas is equal to a voltage of the non-icon hotspot area.

7. The method of claim 5, wherein maximum sensing distance corresponding to the icon hotspot areas to be capable of being sensed and maximum sensing distance corresponding to the non-icon hotspot area to be capable of being sensed are same, and are higher than the first response distance and the second response distance.

8. The method of claim 5, wherein the preset position is the first response distance.

9. The method of claim 1, wherein responding to the touch control operation performed outside the icon hotspot areas comprises aggregating icons.

10. A floating touch control sensing system applicable to a floating touch control electronic device, comprising a touch display panel including a plurality of icon hotspot areas and a non-icon hotspot areas area, the floating touch control sensing system comprising:
a processor;
a bus; and
a computer readable storage coupled to the processor via the bus and configured to store at least one computer executable instruction thereon which, when executed by the processor, causes the processor to carry out actions, comprising:
sensing a floating position of a touch object;
determining whether the floating position is higher than a preset position; and
responding to a touch control operation outside the icon hotspot area, not responding to a touch control operation inside the icon hotspot areas when the floating position is determined to be higher than the preset position.

11. The system of claim 10, wherein the at least one computer executable instruction thereon which, when executed by the processor, further causes the processor to carry out actions, comprising:
responding to a corresponding touch control operation when the floating position is determined to be not higher than the preset position.

12. The system of claim 11, wherein the at least one computer executable instruction thereon which, when executed by the processor, causes the processor to carry out actions, comprising:
sensing an area corresponding to the floating position of the touch object;
outputting a first position signal when the sensed area corresponding to the floating position is located inside the icon hotspot areas;
outputting a second position signal when the sensed area corresponding to the floating position is located outside the icon hotspot areas;
responding to the touch operation corresponding to the icon hotspot areas according to the first position signal; and
responding the touch operation corresponding to the area outside the icon hotspot areas according to the second position signal.

13. The system of claim of claim 10, wherein a voltage corresponding to the plurality of icon hotspot areas is lower than a voltage corresponding to the area outside the icon hotspot areas.

14. The system of claim 10, wherein the at least one computer executable instruction thereon which, when executed by the processor, causes the processor to carry out actions, comprising:
responding a floating touch control operation with a height less than or equal to a first response distance wherein the floating touch control operation corresponds to the icon hotspot areas; and
responding a floating touch control operation with a height less than or equal to a second response distance wherein the floating touch control operation corresponds to the non-icon hotspot area, wherein the first response distance corresponding to the icon hotspot areas is shorter than the second response distance corresponding to the non-icon hotspot area.

15. The system of claim 14, wherein a voltage corresponding to the icon hotspot areas is equal to a voltage corresponding to the non-icon hotspot area.

16. The system of claim 14, wherein maximum sensing distance corresponding to the icon hotspot areas to be capable of being sensed and maximum sensing distance corresponding to the non-icon hotspot area to be capable of being sensed are same, and are higher than the first response distance and the second response distance.

17. The system of claim 14, wherein the preset position is the first response distance.

18. The system of claim of claim 10, wherein the at least one computer executable instruction thereon which, when executed by the processor, causes the processor to carry out actions, comprising:
aggregating icons for responding to the touch control operation outside the icon hotspot areas.

19. A non-transitory computer readable storage medium applicable to a floating touch control electronic device comprising a touch display panel including a plurality of icon hotspot areas and a non-icon hotspot areas area and storing computer programs which, when executed by a processor, are operable with the processor carry out actions comprising:
sensing a floating position of a touch object;
determining whether the floating position is higher than a preset position; and
responding to a touch control operation outside the icon hotspot areas, not responding to a touch control operation inside the icon hotspot areas when the floating position is determined to be higher than the preset position.

20. The non-transitory computer readable storage medium of claim 19, wherein the computer programs which, when executed by the processor, are further operable with the processor carry out actions comprising:
responding to a corresponding touch control operation when the floating position is determined to be not higher than the preset position.
